(19) United States
(12) Patent Application Publication
(10) Pub. No.: US 2012/0151394 A1
(43) Pub. Date: Jun. 14, 2012

(54) USER INTERFACE

(76) Inventor: Antony Locke, Hampshire (GB)

(21) Appl. No.: 12/965,497

(22) Filed: Dec. 10, 2010

(30) Foreign Application Priority Data
Dec. 8, 2010 (GB) 1020782.7

(51) Int. Cl. G06F 3/048

(52) U.S. Cl. 715/765

(57) ABSTRACT

A control unit, comprises a display and a user input device, wherein the control unit is adapted to present on the display an icon representing a state of a controlled device, and to receive via the user input device inputs defining at least two of the position, size and orientation of the icon. The state of the controlled device is then controlled based on the user inputs. The control unit can form part of the controlled device, or the control unit and the controlled device can be in a single device. Alternatively, the control unit may have an interface for a wired or wireless connection to the controlled device. The controlled device can for example be an audio device such as a portable music player, a portable computing device, a communications device such as a mobile phone or a walkie talkie, a portable imaging device, a games console, or a home automation device.

### BACKGROUND OF THE INVENTION

1. Field of the Invention

This invention relates to a user interface, and in particular to a user interface that can be used for controlling various operational parameters of a controlled device.

2. Description of the Related Art

Touch screen devices are becoming common, and it is known to use the touch screen to control various operating parameters of the device that contains the touch screen, or of another device connected to that first device.

For example, the EarPrint software application, described at http://itunes.apple.com/us/app/earprint/id366669446?mt=8, can be used to personalize the characteristics of an audio headset, based on the x- and y-coordinates of the position of a touch input on the screen.

It would be desirable to be able to control more parameters of a controlled device.

### SUMMARY OF THE INVENTION

According to a first aspect of the present invention, there is provided a control unit, comprising: a display; and a user input device, wherein the control unit is adapted to: present on the display an icon or figure representing a state of a controlled device; receive via the user input device inputs defining at least two of the position, size and orientation of the figure; and control the state of the controlled device based on the user inputs.

The control unit may form part of the controlled device, or the control unit and the controlled device may be in a single device, or the control unit may have an interface for a wireless connection to the controlled device, or the control unit may have an interface for a wired connection to the controlled device.

In some embodiments, the control unit is adapted to receive user inputs defining two orthogonal coordinates of the position of the figure, for example horizontal and vertical coordinates of the position of the figure.

In some embodiments, the control unit is adapted to receive user inputs defining two orthogonal coordinates of the size of the figure, for example horizontal and vertical components of the size of the figure.

In some embodiments, the display and the user input device comprise a touch-sensitive screen.

In some embodiments, the control unit is adapted to display a plurality of figures or icons, wherein each figure represents a state of a respective controlled device. In that case, the control unit may be adapted such that each figure is constrained to a respective region of the display. One of the figures may be identified as an active figure, and the control unit adapted such that the state of the controlled device is controlled corresponding to the active figure, based on the user inputs.

According to a second aspect of the present invention, there is provided a method of controlling a controlled device, comprising: displaying a figure representing a state of the controlled device; receiving user inputs defining at least two of the position, size and orientation of the figure; and controlling the state of the controlled device based on the user inputs.

According to a third aspect of the present invention, there is provided a controlled system, comprising: a controlled device; and a control unit, wherein the control unit comprises: a display; and a user input device, wherein the control unit is adapted to: present on the display an icon representing a state of the controlled device; receive via the user input device inputs defining at least two of the position, size and orientation of the figure; and control the state of the controlled device based on the user inputs.

This has the advantage that a larger number of parameters can be controlled, using a single icon on the display.

### BRIEF DESCRIPTION OF THE DRAWINGS

For a better understanding of the present invention, and to show how it may be put into effect, reference will now be made, by way of example, to the accompanying drawings, in which:

FIG. 1 is a schematic diagram of a first system operable in accordance with an embodiment of the present invention;

FIG. 2 is a schematic diagram of a second system operable in accordance with an embodiment of the present invention;

FIG. 3 is a schematic diagram of a third system operable in accordance with an embodiment of the present invention;

FIG. 4 is a schematic diagram of a fourth system operable in accordance with an embodiment of the present invention;

FIG. 5 illustrates a screen display in accordance with an embodiment of the present invention;

FIG. 6 illustrates an alternative screen display in accordance with an embodiment of the present invention; and

FIG. 7 illustrates a further alternative screen display in accordance with an embodiment of the present invention.

### DETAILED DESCRIPTION OF THE PREFERRED EMBODIMENTS

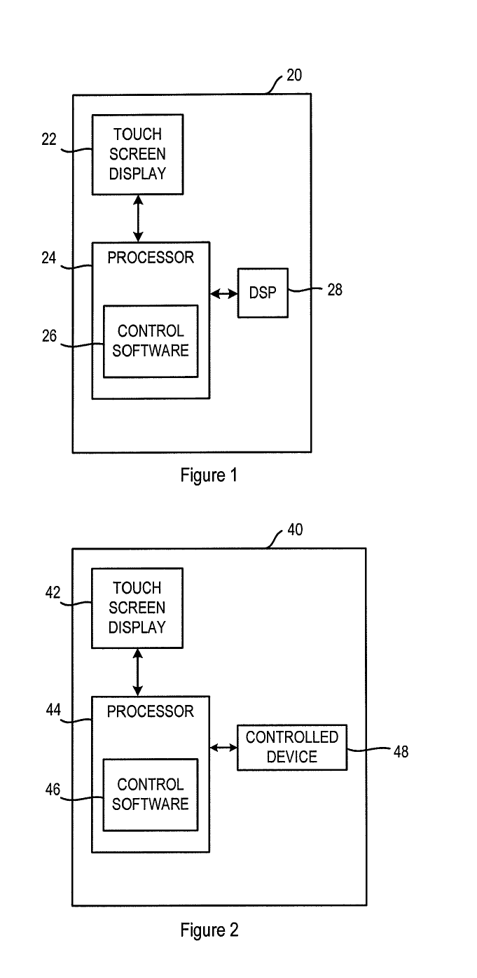

FIG. 1 is a schematic illustration of a unit 20, which may for example be an audio device such as a portable music player, a portable computing device, a communications device such as a mobile phone or a walkie talkie, a portable imaging device, a games console, or a home automation device. The device 20 includes a touch screen display 22, which may for example occupy a large part of one surface of the device 20. At least one part of the function of the device 20 is controlled by a processor 24. Specifically, the processor 24 receives inputs from the touch screen display 22, and controls the display of images on the touch screen display 22, amongst other things.

The processor 24 has control software 26 associated with it. For example, the control software 26 can be permanently stored in memory in the device 20, or the device 20 can be provided with a wired or wireless interface (not shown), allowing such software to be downloaded to the device 20. Such downloadable software, and indeed any downloadable software, may be in the form of a software application, or “App”.

The device 20 also includes a digital signal processor (DSP) 28, running software that controls an aspect of the operation of the device. Again, the software that is run by the DSP 28 can be permanently stored in the device 20, or can be downloaded to the device 20. Such downloadable software, and indeed any downloadable software, may be in the form of a software application, or “App”.

As described in more detail below, inputs provided by means of the touch screen display 22 can be acted upon by the control software 26, in order to control in real time the operation of the software that is run by the DSP 28. For example, in the case where the device 20 is a portable music player, the DSP 28 might be running software that performs ambient noise cancellation (NC). In such a case, it is known that different input signals might advantageously be filtered in different ways, depending on the situation in which the device 20 is being used. Hence, the inputs provided by means of the touch screen display 22 can be acted upon by the control software 26, in order to control in real time the details of the NC filtering algorithms that are carried out in the DSP 28.

The DSP 28 may also have one or more inputs for receiving signals from one or more transducers (not shown in FIG. 1) sensing a parameter being controlled. In this case, the DSP 28 may feed back information to the processor 24. For example, such a transducer may be a temperature sensing transducer, that may feed back a warning to the processor 24 if the temperature of the DSP 28 is too high or low.

FIG. 2 is a schematic illustration of a unit 40, which again may for example be a portable computing device, a portable music player, a portable communications device, a portable imaging device, or a handheld games console. The device 40 includes a touch screen display 42, which may for example occupy a large part of one surface of the device 40. At least one part of the function of the device 40 is controlled by a processor 44. Specifically, the processor 44 receives inputs from the touch screen display 42, and controls the display of images on the touch screen display 42.

The processor 44 has control software 46 loaded on it. For example, the control software 46 can be permanently stored in the device 40, or the device 40 can be provided with a wired or wireless interface (not shown), allowing such software 46 to be downloaded to the device 40.

The device 40 also includes a controlled device 48, for example in the form of an integrated circuit.

As described in more detail below, inputs provided by means of the touch screen display 42 can be acted upon by the control software 46, in order to control in real time the operation of the controlled device 48. For example, in the case where the device 40 is a portable music player, the controlled device 48 might be an integrated circuit, or chip, that comprises a signal equalizer or the like, amongst other things. In such a case, it is known that different types of signal might advantageously be processed by the equalizer in different ways. Hence, the inputs provided by means of the touch screen display 42 can be acted upon by the control software 46, in order to control in real time the details of the signal equalization carried out in the device 48.

The controlled device 48 may also have one or more inputs for receiving signals from one or more transducers (not shown in FIG. 1) sensing a parameter being controlled. In this case, the controlled device 48 may feed back information to the processor 44. For example, such a transducer may be a temperature sensing transducer, that may feed back a warning to the processor 44 if the temperature of the controlled device 48 is too high or low.

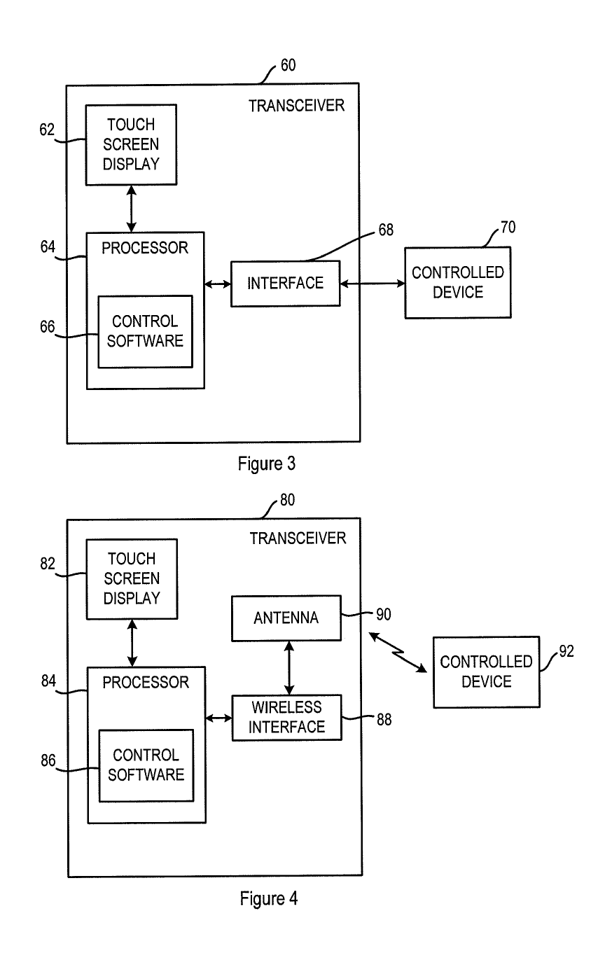

FIG. 3 is a schematic illustration of a unit 60, which again may for example be a portable computing device, a portable music player, a portable communications device, a portable imaging device, or a handheld games console. The device 60 includes a touch screen display 62, which may for example occupy a small part of one surface of the device 60. At least one part of the function of the device 60 is controlled by a processor 64. Specifically, the processor 64 receives inputs from the touch screen display 62, and controls the display of images on the touch screen display 62.

The processor 64 has control software 66 loaded on it. For example, the control software 66 can be permanently stored in the device 60, or the device 60 can be provided with a wired or wireless interface (not shown), allowing such software 66 to be downloaded to the device 60.

The device 60 also includes an interface 68, for connection over a wired connection to a controlled device or system 70 which also comprises a similar interface (not illustrated).

As described in more detail below, inputs provided by means of the touch screen display 62 can be acted upon by the control software 66, in order to control in real time the operation of the controlled device 70. For example, in the case where the device 60 is a portable music player, the controlled device 70 might be a pair of headphones or earphones, which might include signal processing functionality such as noise cancellation or the like. In such a case, it is known that different noise cancellation algorithms might advantageously be used in different environments, for example. Hence, the inputs provided by means of the touch screen display 62 can be acted upon by the control software 66, in order to control in real time the details of the noise cancellation carried out in the device 70.

The wired connection between the control unit 60 and the controlled device 70 may be bidirectional (as illustrated in FIG. 3), meaning that each acts a transceiver. The controlled device 70 may comprise one or more transducers (not shown in FIG. 3) for sensing a parameter being controlled and may feed back information to the control unit 60. For example, the transducer may be a power meter for monitoring the power consumed by a lighting system for example, that may feed back information on how much power has been consumed or if excessive power is being consumed etc.

It is mentioned above that the device 60 may be a portable device having particular functions. However, in this case, the device 60 may simply be a control device, whose only function is to control the operation of one or more controlled device 70.

FIG. 4 is a schematic illustration of a unit 80, which again may for example be a portable computing device, a portable music player, a portable communications device, a portable imaging device, or a handheld games console. The device 80 includes a touch screen display 82, which may for example occupy a large part of one surface of the device 80. At least one part of the function of the device 80 is controlled by a processor 84. Specifically, the processor 84 receives inputs from the touch screen display 82, and controls the display of images on the touch screen display 82.

The processor 84 has control software 86 loaded on it. For example, the control software 86 can be permanently stored in the device 80, or the device 80 can be provided with a wired or wireless interface (not shown), allowing such software 86 to be downloaded to the device 80.

The device 80 also includes an interface 88, for connection to an antenna 90, allowing the transfer of signals over a wireless connection to a controlled device or system 92 which also comprises a corresponding interface (not illustrated). The wireless connection might use Bluetooth™, WiFi, cellular, or any other wireless communications protocol. In the case where the connection between the control unit, i.e. device 80, and the controlled device or system 92, is uni-directional, the control unit may be considered as a transmitter and the controlled device or system 92 may be considered as a receiver. In the case where the connection between the control unit and the controlled device or system 92 is bi-directional, both the control unit and the controlled device or system may each be considered as a transceiver i.e. a transmitter and a receiver.

As described in more detail below, inputs provided by means of the touch screen display 82 can be acted upon by the control software 86, in order to control in real time the operation of the controlled device 92. For example, in the case where the device 80 is a portable communications device, the controlled device 92 might be a Bluetooth™ headset, which might include signal processing functionality such as noise cancellation or the like. In such a case, it is known that different noise cancellation algorithms might advantageously be used in different environments, for example. Hence, the inputs provided by means of the touch screen display 82 can be acted upon by the control software 86, in order to control in real time the details of the noise cancellation carried out in the device 92.

The wireless connection between the control unit 80 and the controlled device 92 may be bidirectional (as illustrated in FIG. 4), meaning that each acts a transceiver. In that case, the controlled device 92 may comprise one or more transducers (not shown in FIG. 4) for sensing a parameter being controlled and may feed back information to the control unit 80. For example, the transducer may be a power meter for monitoring the power consumed by a lighting system for example, that may feed back information on how much power has been consumed or if excessive power is being consumed etc.

It is mentioned above that the device 80 may be a portable device having particular functions. However, in this case, the device 80 may simply be a control device, whose only function is to control the operation of one or more controlled device 92.

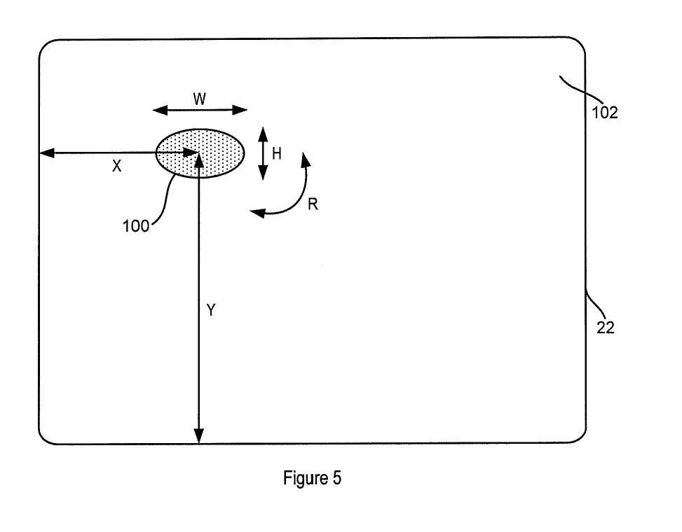

FIG. 5 is a schematic illustration of the touch screen display device 22 in the device 20, in use, it being appreciated that this description applies equally to any of the display devices 42, 62, 82 described above.

The control software 26 (or the respective control software 46, 66, 86, as the case may be) causes a figure or icon, being in this illustrated example an ellipse 100, to be displayed on the display 22, in, for example, a different colour to the background 102.

Based on the touch inputs that the screen detects, the control software 26 causes the features of this display to be altered, and also alters the operational parameters of the DSP 28 (or, equally, of the respective controlled device 48, 70, 92).

For example, if the screen detects a single touch within the ellipse 100, and the position of this touch moves within the display 22, the control software 26 causes the position of the ellipse 100 to move in a corresponding way.

Thus, the distance X from the left hand edge of the display 22 directly represents a value of an operational parameter of the DSP 28, and this can easily be controlled by the user of the device 20.

Similarly, the distance Y from the bottom edge of the display 22 directly represents a value of a second operational parameter of the DSP 28, and this can similarly be controlled by the user of the device 20.

As another example, if the screen detects two touches within the ellipse 100, or close to the border of the ellipse 100, and the positions of these touches move closer together or further apart within the display 22, the control software 26 causes the size of the ellipse 100 to move in a corresponding way. If the positions of the touches move closer together, the ellipse becomes smaller, while if the positions of the touches move further apart, the ellipse becomes larger.

Thus, the horizontal component, or width, W, of the ellipse 100 directly represents a value of a third operational parameter of the DSP 28, and this can be directly controlled by the user of the device 20.

Similarly, the vertical component, or height, H, of the ellipse directly represents a value of a fourth operational parameter of the DSP 28, which again can be directly controlled by the user of the device 20.

As a further example, if the screen detects a single touch outside the ellipse 100, and the position of this touch moves within the display 22, the control software 26 causes the position of the ellipse 100 to move in a corresponding way.

Thus, the rotational orientation R of the ellipse 100 within the display 22 directly represents a value of a fifth operational parameter of the DSP 28, and this can also be controlled by the user of the device 20.

Thus, together, in this embodiment, the user can control the values of five parameters by altering the position, size and orientation of the ellipse 100.

For example, in the situation where the DSP 28, or the other controlled device 48, 70, 92, is providing or controlling an audio output on the device 20, or the other respective device, the five inputs might be used to control five operational parameters of the audio output, as follows.

| Display parameter | Operational parameter |
|---|---|
| X | Left/right stereo panning |
| Y | Volume |
| W | Stereo width |
| H | Compression |
| R | Active Noise Cancellation Gain |

Specifically, in this example, these operational parameters are controlled in real time, so that the effects of the control are noticeable by the user effectively immediately.

In other examples, setting of the inputs might cause the operational parameters to change at some future time. For example, in the case of a home or building automation system, the operational parameters might relate to the heating, lighting or alarm status of a room or building during a particular time period. For example, the operational parameters might relate to the set temperature of a heating/cooling system and the brightness of a lighting system during a forthcoming night time period.

Of course, the same input parameters, controlled by means of touch inputs on the display 22, can be used to control completely different operational parameters in the case of a different controlled device.

Embodiments have been described above in which a FIG. 100 takes the form of an ellipse. However, other figures can be displayed as alternatives. For example, a figure in the form of a rectangle or other polygon can be displayed in the same manner as the ellipse 100, in order to control the same number of parameters.

In addition, embodiments have been described above in which a single figure is presented on the display. However, multiple figures or icons may be presented, with each being used to display the status of a respective controlled device, and user inputs being able to control multiple parameters defining the statuses of the devices.

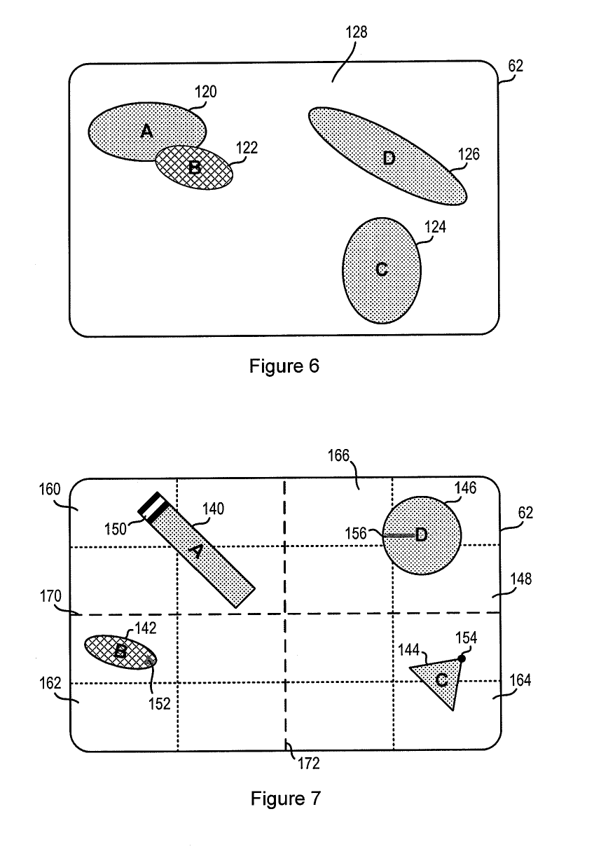

FIG. 6 is a schematic illustration of the touch screen display device 62 in the device 60, in use, it being appreciated that this description applies equally to any of the display devices 22, 42, 82 described above.

The control software 66 (or the respective control software 26, 46, 86, as the case may be) causes various figures, namely ellipses 120, 122, 124, 126 to be displayed on the display 62.

These ellipses are displayed in different colours to the background 128, but in other examples they could have other distinguishing visual features or additions in the form of text or numerals. The ellipses are presented in ways which allow them to be distinguished from each other. In this illustrated example, the ellipses are identified by alphanumeric characters. Specifically, the ellipse 120 is identified by the letter A; the ellipse 122 is identified by the letter B; the ellipse 124 is identified by the letter C; and the ellipse 126 is identified by the letter D.

The ellipses 120, 122, 124, 126 typically relate to different controlled devices, or to different components of a controlled system. For example, the touch screen display device 62 can be used as the control for a home automation system. In such a case, the ellipses 120, 122, 124, 126 might be used to represent the different rooms or zones in a property.

Further, one of the ellipses 120, 122, 124, 126 is active at any given time. For example, an ellipse might be activated by a rapid double tap on the touch screen within the ellipse. The active figure is then further distinguishable from the other figures presented on the display. Thus, as shown in FIG. 6, the active ellipse is the ellipse 122 identified by the letter B, which is shown in a different colour from the other ellipses.

Based on the touch inputs that the screen detects, the control software causes the features of the active figure in the display to be altered, and also alters the operational parameters of the home automation system in the respective room or zone of the property.

As before, if the screen detects a single touch within the active ellipse 122, and the position of this touch moves within the display 62, the control software 66 causes the position of the ellipse 122 to move in a corresponding way. Thus, the distance from the left hand edge of the display 62 directly represents a value of an operational parameter of the home automation system, and this can easily be controlled by the user of the device 60. Similarly, the distance from the bottom edge of the display 62 directly represents a value of a second operational parameter of the home automation system, and this can similarly be controlled by the user of the device 60.

If the screen detects two touches within the ellipse 122, or close to the border of the ellipse 122, and the positions of these touches move closer together or further apart within the display 62, the control software 66 causes the size of the ellipse 122 to move in a corresponding way. If the positions of the touches move closer together, the ellipse becomes smaller, while if the positions of the touches move further apart, the ellipse becomes larger. Thus, the horizontal component, or width, of the ellipse 122 directly represents a value of a third operational parameter of the home automation system, and this can be directly controlled by the user of the device 60. Similarly, the vertical component, or height, of the ellipse directly represents a value of a fourth operational parameter of the home automation system, which again can be directly controlled by the user of the device 60.

If the screen detects a single touch outside the ellipse 122, and the position of this touch moves within the display 62, the control software 66 causes the position of the ellipse 122 to move in a corresponding way. Thus, the rotational orientation of the ellipse 122 within the display 62 directly represents a value of a fifth operational parameter of the home automation system, and this can also be controlled by the user of the device 60.

Thus, together, in this embodiment, the user can control the values of five parameters by altering the position, size and orientation of the ellipse 122.

For example, in this example of a home automation system, the four ellipses 120, 122, 124, 126 might be used to represent the different rooms or zones in a property, as mentioned above. In each of these rooms or zones, the position of the ellipse might be used to represent the state of the lighting system, and to control it; the size of the ellipse might be used to represent the state of the air conditioning system, and to control it; and the orientation of the ellipse might be used to represent the state of the audio system, and to control it. In more detail, the horizontal position of the ellipse might be used to represent the brightness of the lighting in a room; the vertical position of the ellipse might be used to represent the colour balance of the lighting in the room; the horizontal size of the ellipse might be used to represent the fan speed of the air conditioning system; the vertical size of the ellipse might be used to represent the set temperature of the air conditioning system; and the orientation of the ellipse might be used to represent the volume of the audio system.

If more or fewer parameters are required, different figures can be displayed. For example, if four parameters are required, the figure can be in the form of a triangle, with the input parameters being the horizontal position, the vertical position, the size, and the orientation of the triangle.

FIG. 7 is a schematic illustration of an alternative form of the touch screen display device 62 in the device 60, in which different shapes are presented, it being appreciated that this description applies equally to any of the display devices 22, 42, 82 described above.

The control software 66 (or the respective control software 26, 46, 86, as the case may be) causes various figures, namely a rectangle 140, an ellipse 142, a triangle 144, and a circle 146 to be displayed on the display 62.

These figures are displayed in different colours to the background 148. The figures are also presented in ways which allow them to be easily distinguished from each other. Thus, while the figures are different shapes, they are also identified by alphanumeric characters, which may help to remind the user which functions are controlled by each figure. Specifically, the rectangle 140 is identified by the letter A; the ellipse 142 is identified by the letter B; the triangle 144 is identified by the letter C; and the circle 146 is identified by the letter D.

As described above, the FIGS. 140, 142, 144, 146 typically relate to different controlled devices, or to different components of a controlled system.

In addition, each of the FIGS. 140, 142, 144, 146 has a respective direction marker. Thus, the rectangle 140 has stripes 150 at one end; the ellipse 142 has an arrow 152 pointing to one location on its circumference; the triangle 144 has a marker 154 on one vertex; and the circle 146 has a line 156 along one radius. These direction markers are used to assist in determining the rotational orientation of the figure at any time.

In this embodiment, each of the FIGS. 140, 142, 144, 146 is confined to a respective area of the display 62. Thus, the rectangle 140 is confined to the upper left corner 160 of the display 62; the ellipse 142 is confined to the lower left corner 162 of the display 62; the triangle 144 is confined to the lower right corner 164 of the display 62; and the circle 146 is confined to the upper right corner 166 of the display 62, with these corners being defined by a horizontal boundary 170 and a vertical boundary 172.

Further, one of the FIGS. 140, 142, 144, 146 is active at any given time. For example, a figure might be activated by a tap within the relevant corner 160, 162, 164, 166 of the touch screen. The active figure is then further distinguishable from the other figures presented on the display. Thus, as shown in FIG. 7, the active figure is the ellipse 142 identified by the letter B, which is shown in a different colour from the other figures.

Based on the touch inputs that the screen detects, the control software causes the features of the active figure in the display to be altered, and also alters the operational parameters of the controlled system.

As before, if the screen detects a single touch within the active ellipse 142, and the position of this touch moves within the lower left corner 162, the control software 66 causes the position of the ellipse 142 to move in a corresponding way. Thus, the distance from the left hand edge of the lower left corner 162 directly represents a value of an operational parameter of the controlled system, and this can easily be controlled by the user of the device 60. Similarly, the distance from the bottom edge of the lower left corner 162 directly represents a value of a second operational parameter of the controlled system, and this can similarly be controlled by the user of the device 60.

If the screen detects two touches within the ellipse 142, or close to the border of the ellipse 142, and the positions of these touches move closer together or further apart within the display 62, the control software 66 causes the size of the ellipse 142 to move in a corresponding way. If the positions of the touches move closer together, the ellipse becomes smaller, while if the positions of the touches move further apart, the ellipse becomes larger. Thus, the horizontal component, or width, of the ellipse 142 directly represents a value of a third operational parameter of the system, and this can be directly controlled by the user of the device 60. Similarly, the vertical component, or height, of the ellipse 142 directly represents a value of a fourth operational parameter of the system, which again can be directly controlled by the user of the device 60.

If the screen detects a single touch outside the ellipse 142 within the lower left corner 162, and the position of this touch moves, the control software 66 causes the position of the ellipse 142 to move in a corresponding way. Thus, the rotational orientation of the ellipse 142, for example the rotation of the arrow 152 relative to the vertical, directly represents a value of a fifth operational parameter of the controlled system, and this can also be controlled by the user of the device 60.

Thus, together, in this embodiment, the user can control the values of five parameters by altering the position, size and orientation of the ellipse 142.

As mentioned above, differently shaped figures might be used to control systems that have different numbers of parameters. For example, in the case of the rectangle 140, the position of the centre of the rectangle might be fixed, while the length and the rotational orientation of the rectangle might be controllable by the user to control two parameters of the controlled system.

As another example, in the case of the triangle 144, the size of the triangle might be fixed, while the X- and Y-positions of the centre of the triangle, and the orientation of the triangle might be controllable by the user to control three parameters of the controlled system.

As a further example, in the case of the circle 146, the orientation of the circle might be irrelevant, while the X- and Y-positions of the centre of the circle, and the radius of the circle, might be controllable by the user to control three parameters of the controlled system.

If a larger number of parameters are required, the figure can for example take the form of a star polygon, with its vertex regions being distinguishable, for example being presented as different colours, and the sizes of the vertex regions being independently controllable by touch inputs within these regions. As in the case of the ellipse, the position and orientation of the figure can also be controlled by the user inputs.

In addition, while embodiments have been described above in which the state of the controlled device, or its operational parameters, are displayed on a touch screen, and are then controlled by means of inputs on the touch screen, any user controlled transducer can be used. Thus, the relevant figure can be displayed on a conventional, non-touch sensitive screen, and the relevant user inputs can be made by a separate transducer, such as a touchpad, rollerball or similar, or such as a mouse or joystick. Alternatively, the user inputs can be made by a suitable voice activation scheme, in which the voice input identifies the parameter to be changed, and the nature of the required change. Equally, the user inputs can be made by a gesture recognition system, for example allowing the controlled device, or its operational parameters, to be controlled simply by pointing at a display screen, without requiring any physical contact between the user and the screen.

Various uses of the system have been described above. As further non-exhaustive examples, the controlled system might for example be: a lighting system, having one or more lights, with controllable brightness, colour, etc; a television or PC monitor or display, with configurable contrast, brightness etc; an air conditioning system, with different temperature zones, having controllable temperature, fan speeds, etc; an adjustable vehicle seat, having a heater, plus a controllable height, forward/rearward position, angle of recline, etc; a mixing device, with different volumes, tones, etc for different tracks representing different instruments or the like; a surround sound audio system, with adjustable tones and/or volumes for different speakers.

There is thus described a user interface, which in certain embodiments allows a user to control multiple operational parameters of a controlled device by means of inputs relating to a single figure.

What is claimed is:

1. A control unit, comprising:
a display; and
a user input device,
wherein the control unit is adapted to:
present on the display an icon representing a state of a controlled device;
receive via the user input device inputs defining at least two of the position, size and orientation of the icon; and
control the state of the controlled device based on the user inputs.

2. A control unit as claimed in claim 1, wherein the control unit forms part of the controlled device.

3. A control unit as claimed in claim 1, wherein the control unit and the controlled device are in a single device.

4. A control unit as claimed in claim 1, having an interface for a wireless connection to the controlled device.

5. A control unit as claimed in claim 1, having an interface for a wired connection to the controlled device.

6. A control unit as claimed in claim 1, wherein the control unit is adapted to receive user inputs defining two orthogonal coordinates of the position of the icon.

7. A control unit as claimed in claim 1, wherein the control unit is adapted to receive user inputs defining horizontal and vertical coordinates of the position of the icon.

8. A control unit as claimed in claim 1, wherein the control unit is adapted to receive user inputs defining two orthogonal coordinates of the size of the icon.

9. A control unit as claimed in claim 8, wherein the user inputs defining the size of the icon comprise inputs defining horizontal and vertical components of the size of the icon.

10. A control unit as claimed in claim 1, wherein the display and the user input device comprise a touch-sensitive screen.

11. A control unit as claimed in claim 1, wherein the control unit is adapted to display a plurality of icons, wherein each icon represents a state of a respective controlled device.

12. A control unit as claimed in claim 11, wherein the control unit is adapted such that each icon is constrained to a respective region of the display.

13. A control unit as claimed in claim 11, wherein one of the icons is identified as an active icon, and the control unit is adapted such that the state of the controlled device is controlled corresponding to the active icon, based on the user inputs.

14. A method of controlling a controlled device, comprising:
displaying a figure representing a state of the controlled device;
receiving user inputs defining at least two of the position, size and orientation of the figure; and
controlling the state of the controlled device based on the user inputs.

15. A method as claimed in claim 14, wherein the user inputs defining the position of the figure comprise inputs defining two orthogonal coordinates of the position of the figure.

16. A method as claimed in claim 15, wherein the user inputs defining the position of the figure comprise inputs defining horizontal and vertical coordinates of the position of the figure.

17. A method as claimed in claim 14, wherein the user inputs defining the size of the figure comprise inputs defining two orthogonal coordinates of the size of the figure.

18. A method as claimed in claim 17, wherein the user inputs defining the size of the figure comprise inputs defining horizontal and vertical components of the size of the figure.

19. A method as claimed in claim 14, comprising displaying the figure on a touch-sensitive screen, wherein the user inputs comprise touch inputs on the screen.

20. A method as claimed in claim 14, comprising displaying the figure on a display of a unit, wherein the controlled device is a component of said unit.

21. A method as claimed in claim 14, comprising displaying the figure on a display of a unit, wherein the controlled device has a wired connection to said unit.

22. A method as claimed in claim 14, comprising displaying the figure on a display of a unit, wherein the controlled device has a wireless connection to said unit.

23. A method as claimed in claim 14, comprising displaying a plurality of figures, wherein each figure represents a state of a respective controlled device.

24. A method as claimed in claim 23, wherein each figure is constrained to a respective region of the display.

25. A method as claimed in claim 23, wherein one of the figures is identified as an active figure, and the method comprises controlling the state of the controlled device corresponding to the active figure, based on the user inputs.

26. A method of controlling a controlled device, the method comprising:
displaying an icon representing a state of the controlled device, wherein at least two of the position, size and orientation of the icon represent aspects of the state of the controlled device;
receiving user inputs; and
controlling the state of the controlled device, and the display of the icon, based on the user inputs.

27. A controlled system, comprising:
a controlled device; and
a control unit, wherein the control unit comprises:
a display; and
a user input device,
wherein the control unit is adapted to:
present on the display an icon representing a state of the controlled device;
receive via the user input device inputs defining at least two of the position, size and orientation of the icon; and
control the state of the controlled device based on the user inputs.

28. A controlled system as claimed in claim 27, wherein the control unit and the controlled device are in a single device.

29. A controlled system as claimed in claim 27, wherein the control unit and the controlled device have a wireless connection.

30. A controlled system as claimed in claim 27, wherein the control unit and the controlled device have a wired connection.

31. A controlled system as claimed in claim 27, wherein the control unit is adapted to receive user inputs defining two orthogonal coordinates of the position of the icon.

32. A controlled system as claimed in claim 31, wherein the control unit is adapted to receive user inputs defining horizontal and vertical coordinates of the position of the icon.

33. A controlled system as claimed in claim 27, wherein the control unit is adapted to receive user inputs defining two orthogonal coordinates of the size of the icon.

34. A controlled system as claimed in claim 33, wherein the user inputs defining the size of the icon comprise inputs defining horizontal and vertical components of the size of the icon.

35. A controlled system as claimed in claim 27, wherein the display and the user input device comprise a touch-sensitive screen.

36. A controlled system as claimed in claim 27, wherein the control unit is adapted to display a plurality of icons, wherein each icon represents a state of a respective controlled device.

37. A controlled system as claimed in claim 36, wherein the control unit is adapted such that each icon is constrained to a respective region of the display.

38. A controlled system as claimed in claim 36, wherein one of the icons is identified as an active icon, and the control unit is adapted such that the state of the controlled device is controlled corresponding to the active icon, based on the user inputs.
